(19) United States
(12) Patent Application Publication
(10) Pub. No.: US 2026/0143329 A1
(43) Pub. Date: May 21, 2026

(54) DUAL SIM DUAL ACTIVE CONTROL METHOD, ELECTRONIC DEVICE, READABLE STORAGE MEDIUM, AND CHIP

(71) Applicant: Huawei Technologies Co., Ltd., Shenzhen (CN)

(72) Inventors: Ming Zhou, Shenzhen (CN); Jie Wang, Shanghai (CN); Bao Wang, Shanghai (CN); Hui Li, Shenzhen (CN); Rentian Ding, Shenzhen (CN)

(21) Appl. No.: 19/451,586

(22) Filed: Jan. 16, 2026

Related U.S. Application Data
(63) Continuation of application No. PCT/CN2024/101317, filed on Jun. 25, 2024.

(30) Foreign Application Priority Data
Jul. 19, 2023 (CN) 202310889783.2
Jun. 20, 2024 (CN) 202410801098.4

(51) Int. Cl. H04W 8/18; H04W 4/021; H04W 64/00; H04W 88/06

(52) U.S. Cl. CPC H04W 8/18; H04W 4/021; H04W 64/00; H04W 88/06

(57) ABSTRACT

This application provides a dual SIM dual active control method. The method is applied to an electronic device. The electronic device supports disposing of a first SIM card and a second SIM card. The method includes: determining a location of the electronic device; and enabling, when the location of the electronic device is within a preset geo-fence and the electronic device is processing a target service, a DSDA function, to establish two service flows by using the first SIM card and the second SIM card to simultaneously transmit service data of the target service.

### CROSS-REFERENCE TO RELATED APPLICATIONS

This application is a continuation of International Application No. PCT/CN2024/101317, filed on Jun. 25, 2024, which claims priority to Chinese Patent Application No. 202310889783.2, filed on Jul. 19, 2023 and Chinese Patent Application No. 202410801098.4, filed on Jun. 20, 2024. All of the aforementioned patent applications are hereby incorporated by reference in their entireties.

### TECHNICAL FIELD

This application relates to the field of wireless communication technologies, and in particular, to a dual SIM dual active control method, an electronic device, a readable storage medium, and a chip.

### BACKGROUND

Dual SIM dual active (DSDA) is a technology in which an electronic device uses two subscriber identity module (SIM) cards to communicate at the same time. For example, in a process of using a SIM card 1 to access the Internet or make a call, the electronic device may further use a SIM card 2 to perform a service such as a calling service, a called service, or an Internet access service. Currently, in a high-speed communication scenario such as large file downloading and live streaming, the electronic device can use two SIM cards to establish two service flows based on the DSDA technology and simultaneously transmit service data, thereby increasing a communication rate. However, a DSDA function consumes a relatively large amount of traffic of the SIM card, which easily causes a waste of traffic resources.

### SUMMARY

This application provides a dual SIM dual active control method, an electronic device, a readable storage medium, and a chip, to solve a problem in the conventional technology that a DSDA function easily causes a waste of traffic resources of an electronic device.

To achieve the foregoing objective, this application uses the following technical solutions.

According to a first aspect, an embodiment of this application provides a dual SIM dual active control method, applied to an electronic device. The electronic device supports disposing of a first SIM card and a second SIM card. The method includes: determining a location of the electronic device; and enabling, when the location of the electronic device is within a preset geo-fence and the electronic device is processing a target service, a DSDA function, to establish two service flows by using the first SIM card and the second SIM card to simultaneously transmit service data of the target service.

In this embodiment, the electronic device configures the DSDA function to take effect within the preset geo-fence, and establishes two service flows based on the DSDA function to process the target service. This not only can meet a requirement of a user for quickly processing the target service to some extent, but also avoid a waste of traffic resources caused by enabling the DSDA function for a long time, thereby improving user experience and having relatively good comprehensive use experience.

In some embodiments, enabling, when the location of the electronic device is within the preset geo-fence and the electronic device is processing the target service, the DSDA function, to establish the two service flows by using the first SIM card and the second SIM card to simultaneously transmit the service data of the target service includes: when the location of the electronic device is within the preset geo-fence and the electronic device is performing the target service, obtaining wireless network information within the geo-fence, where the wireless network information is used to represent historical communication statuses of a plurality of other electronic devices; and when the wireless network information meets a preset network condition, enabling the DSDA function, to establish the two service flows by using the first SIM card and the second SIM card to simultaneously transmit the service data of the target service.

In this embodiment, the electronic device uses the wireless network information within the geo-fence as a prerequisite for enabling the DSDA function, and enables the DSDA function only when the wireless network information meets the preset network condition, so as to ensure communication quality of the electronic device in a DSDA mode.

In some embodiments, the wireless network information includes at least one of: operator information, a frequency band number, signal strength, an uplink/downlink congestion situation, a delay, a jitter, and a packet loss rate.

In some embodiments, the preset network condition includes: The frequency band number in the wireless network information includes a frequency band number in a DSDA frequency band combination supported by the electronic device.

In some embodiments, the preset network condition further includes: The signal strength is greater than a signal strength threshold; and/or the delay is less than a delay threshold; and/or time of the jitter is less than a jitter time threshold; and/or the packet loss rate is less than a packet loss rate threshold.

In some embodiments, the geo-fence includes a plurality of sub-regions. Correspondingly, obtaining the wireless network information within the geo-fence includes: sending location information of a current location of the electronic device to a network side device; and receiving the wireless network information that is of a first sub-region in which the electronic device is located and that is returned by the network side device, where the first sub-region is determined by the network side device within the geo-fence based on the location information. Based on a communication map, the wireless network information determined by the electronic device is more accurate.

In some embodiments, the sub-region is a grid of a preset shape, a cell, or the like. It should be noted that a smaller sub-region indicates higher precision of the communication map.

In some embodiments, enabling the DSDA function includes: determining a device status of the electronic device; and enabling the DSDA function when the device status meets a device status condition. For example, the device status condition includes: a temperature of the electronic device is less than a temperature threshold; and/or a remaining battery level of the electronic device is greater than a battery level threshold. According to the method, overheating of the device can be avoided, and secure running of the device can be ensured; or excessive power consumption of the electronic device, causing power-off of the electronic device, can be avoided.

In some embodiments, enabling the DSDA function includes: determining a data amount of the service data of the target service; and when the data amount is greater than a data amount threshold, enabling the DSDA function. According to the method provided in this embodiment, the electronic device may enable the DSDA function when transmitting a relatively large file, so as to accelerate a transmission rate and improve user experience; and when transmitting a relatively small file, data traffic of a default SIM card is used, so as to reduce consumption of traffic of the other SIM card.

In some embodiments, enabling the DSDA function includes: determining a data transmission rate at which the electronic device currently transmits the service data of the target service; and when the data transmission rate is less than a rate threshold, enabling the DSDA function. This method can reduce power consumption of the device.

In some embodiments, a setting interface of the electronic device includes a first control, and the first control is used to control enabling or disabling of the DSDA function.

In some embodiments, enabling, when the location of the electronic device is within the preset geo-fence and the electronic device is processing the target service, the DSDA function, to establish the two service flows by using the first SIM card and the second SIM card to simultaneously transmit the service data of the target service includes: displaying a first prompt box when the location of the electronic device is within the preset geo-fence and the electronic device is processing the target service, where the first prompt box includes query information and a confirm control, and the query information is used to query a user whether to enable the dual SIM dual active function; and enabling, by the electronic device, the DSDA function in response to a selection operation for the confirm control, to establish the two service flows by using the first SIM card and the second SIM card to simultaneously transmit the service data of the target service.

In some embodiments, the method further includes: displaying a second control in a process of establishing the two service flows by using the first SIM card and the second SIM card to simultaneously transmit the service data of the target service, where the second control is used to control disabling of the DSDA function of the electronic device.

In some embodiments, after the DSDA function is enabled, when frequency band numbers currently for the first SIM card and the second SIM card to communicate cannot form the DSDA combination supported by the electronic device, the method further includes: when the first SIM card is in a radio resource control RRC connected state, and the second SIM card is in an RRC idle state, performing cell reselection on a cell on which the second SIM card camps, where a frequency band number of a target cell on which the second SIM card camps after reselection is able to form the DSDA combination with the frequency band number currently for the first SIM card to communicate.

In some embodiments, after the DSDA mode is enabled, when frequency band numbers currently for the first SIM card and the second SIM card to communicate cannot form the DSDA combination supported by the electronic device, the method further includes: when both the first SIM card and the second SIM card are in the RRC connected state, if the first SIM card is disconnected from a current serving cell, controlling the second SIM card to determine a target cell and establish an RRC connection to the target cell by using an RRC reestablishment procedure, where a frequency band number of the target cell is able to form the DSDA combination with the frequency band number currently used by the second SIM card to communicate.

In some embodiments, the method further includes: disabling the DSDA function after it is detected that the electronic device leaves the preset geo-fence.

According to a second aspect, an embodiment of this application provides an electronic device. The electronic device supports disposing of a first subscriber identity module SIM card and a second SIM card, and includes a memory, a processor, and a computer program that is stored in the memory and that is capable of running on the processor, and when executing the computer program, the processor implements the dual SIM dual active control method shown in the first aspect.

According to a third aspect, an embodiment of this application provides a computer-readable storage medium. The computer-readable storage medium stores a computer program. When the computer program is executed by a processor, the dual SIM dual active control method shown in the first aspect is implemented.

According to a fourth aspect, an embodiment of this application provides a chip. The chip includes a processor and a memory. The memory stores a computer program. When the computer program is executed by the processor, the dual SIM dual active control method shown in the first aspect is implemented.

According to a fifth aspect, an embodiment of this application provides a computer program product, where the computer program product stores a computer program, and when the computer program is run by a processor, the dual SIM dual active control method shown in the first aspect can be implemented.

It may be understood that, for beneficial effects of the second aspect to the fifth aspect, reference may be made to related descriptions in the first aspect. Details are not described herein again.

### BRIEF DESCRIPTION OF THE DRAWINGS

FIG. 1 is a diagram of a structure of a DSDA communication system according to an embodiment of this application;

FIG. 2 is a diagram of a DSDA communication scenario according to an embodiment of this application;

FIG. 3 is a schematic flowchart of a dual SIM dual active control method according to an embodiment of this application;

FIG. 4 is a diagram of a geo-fence according to an embodiment of this application;

FIG. 5 is a schematic flowchart of a DSDA control method according to another embodiment of this application;

FIG. 6 is a diagram of a communication map according to an embodiment of this application;

FIG. 7 is a diagram of a process of determining a communication map according to an embodiment of this application;

FIG. 8 is a schematic flowchart of obtaining wireless network information by an electronic device according to an embodiment of this application;

FIG. 9 is a display diagram of a first control according to an embodiment of this application;

FIG. 10 is a display diagram of a first prompt box according to an embodiment of this application;

FIG. 11A is a diagram of a second prompt box according to an embodiment of this application;

FIG. 11B is a diagram of a third prompt box according to an embodiment of this application;

FIG. 12 is a schematic flowchart of performing cell reselection by an electronic device according to an embodiment of this application; and

FIG. 13 is a diagram of a structure of a chip according to an embodiment of this application.

### DETAILED DESCRIPTION OF ILLUSTRATIVE EMBODIMENTS

The following describes technical solutions provided in embodiments of this application with reference to the accompanying drawings.

It should be understood that, in the description of embodiments of this application, “/” indicates “or”, unless otherwise specified. For example, A/B may indicate A or B. The term “and/or” in this specification describes only an association relationship between associated objects, and indicates that three relationships may exist. For example, A and/or B may indicate the following three cases: Only A exists, both A and B exist, and only B exists.

The terms “first” and “second” in embodiments are merely intended for a purpose of description, and shall not be understood as an indication or an implication of relative importance or an implicit indication of a quantity of indicated technical features. Therefore, a feature limited by “first” or “second” may explicitly or implicitly include one or more features. In the description of embodiments, unless otherwise specified, “a plurality of” means two or more.

The technical solutions in embodiments of this application may be applied to various communication systems, for example, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system or new radio (NR), new radio (New Radio, NR), a global system for mobile communications (GSM), a code division multiple access (CDMA) communication system, and a time division-synchronous code division multiple access (TD-SCDMA) communication system.

With development of communication technologies, many electronic devices support a dual SIM dual active (DSDA) technology, that is, support simultaneous communication by using two subscriber identity module (SIM) cards, to implement concurrent dual-SIM services. For example, in a process of using a SIM card 1 to access the Internet or make a call, the electronic device may further use a SIM card 2 to perform a service such as a calling service, a called service, or an Internet access service, thereby having relatively good user experience.

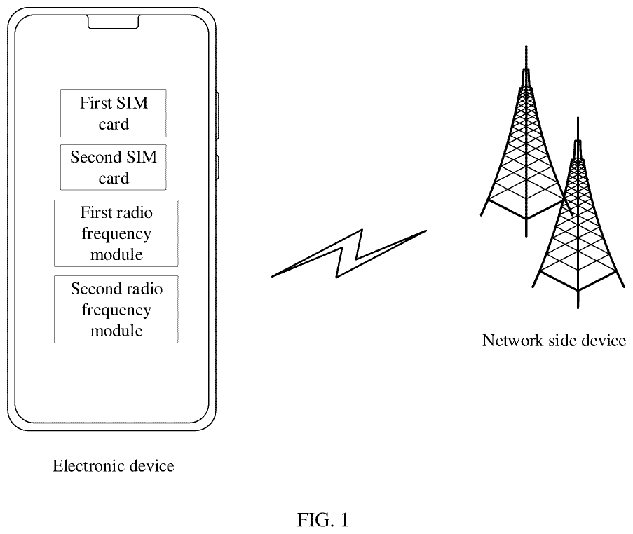

FIG. 1 is a diagram of a structure of a DSDA communication system according to an embodiment of this application. Refer to FIG. 1. The communication system includes an electronic device and one or more network side devices, and each network side device and the electronic device support communication by using a cellular communication technology such as LTE or NR. LTE may be replaced with 4G for description, and NR may be replaced with 5G for description.

The network side device may be a device that can provide a random access function for the electronic device, or a chip that can be disposed in the device. The device includes but is not limited to: an evolved NodeB (eNB), a radio network controller (RNC), a NodeB (NB), a base station controller (BSC), a base transceiver station (BTS), a home NodeB (for example, a home evolved NodeB, or a home NodeB, HNB), and a baseband unit (BBU). In addition, the device may be: a gNB or a transmission point (TRP or TP) in a 5G system such as an NR system, or one or a group (including a plurality of) of antenna panels of a base station in a 5G system; or may be a network node that forms a gNB or a transmission point, such as a baseband unit (BBU) or a distributed unit (DU), a network side device in a future 5G network, or a network side device in a future evolved public land mobile network (PLMN). This is not limited in this embodiment of this application.

The electronic device may be an electronic device, such as a mobile phone, a tablet computer, a wearable device (for example, a smart watch), an in-vehicle device, an augmented reality (AR)/virtual reality (VR) device, a notebook computer, an ultra-mobile personal computer (UMPC), a netbook, or a personal digital assistant (PDA). A specific type of the electronic device is not limited in this embodiment of this application.

In this embodiment, the electronic device supports disposing of two SIM cards, and includes two radio frequency modules. In this embodiment, the two SIM cards are respectively referred to as a first SIM card and a second SIM card, and the two radio frequency modules are respectively referred to as a first radio frequency module and a second radio frequency module. Certainly, in some other embodiments, more SIM cards or more radio frequency modules may alternatively be disposed in the electronic device.

The SIM card may be a physical SIM card, an embedded SIM card (that is, an e-SIM card), a virtual SIM card, or the like. The physical SIM card may be a SIM card of a different size, such as a common SIM card, a micro-SIM card, or a nano-SIM card. The electronic device may interact with the network side device by using the SIM card, to implement functions such as a cellular call and Internet access. The SIM card stores an international mobile subscriber identification number (IMSI), and the IMSI is a unique subscriber identity for user equipment to access a cellular network. When accessing the network side device, the user equipment needs to undergo authentication by using the IMSI, so that the network side device identifies the identity of the user equipment.

It should be noted that the first SIM card and the second SIM card of the electronic device may be SIM cards of a same operator, or may be SIM cards of different operators. This is not limited in this embodiment. Because different operators usually support different communication frequency bands, SIM cards of different operators usually have different communication frequency bands.

In addition, network types supported by the first SIM card and the second SIM card of the electronic device may be the same, or may be different. The network type may be an LTE network, an NR network, or the like. For example, the first SIM card supports the LTE network but does not support the NR network, and the second SIM card supports both the LTE network and the NR network. For another example, both the first SIM card and the second SIM card support both the LTE network and the NR network. Communication frequency bands supported by different types of networks are usually different.

In this embodiment, a frequency band is a frequency range of a radio signal, for example, 1920 MHz to 1980 MHz, or 2110 MHz to 2170 MHz. A frequency band of the radio signal includes but is not limited to a frequency band of an LTE signal and a frequency band of an NR signal. Different frequency bands may be represented by using different frequency band numbers. For example, different frequency bands of the LTE signal may be represented by using LTE frequency band numbers such as B1, B2, B3, . . . , and B41, and frequency bands of the NR signal may be represented by using NR frequency band numbers such as n1, n2, n3, . . . , and n87.

The radio frequency module is configured to send an uplink signal and receive a downlink signal in a communication process. Specifically, in an uplink communication process, the radio frequency module converts a binary signal into a radio electromagnetic wave signal and sends the radio electromagnetic wave signal to the network side device. In a downlink communication process, the radio frequency module receives an electromagnetic wave signal sent by the network side device, and converts the electromagnetic wave signal into a binary signal.

In some embodiments, the radio frequency module includes a radio frequency front end and an antenna. The radio frequency front end includes a transmit channel and a receive channel, and the antenna includes a transmit antenna (that is, a Tx antenna) and a receive antenna (that is, an Rx antenna). The transmit channel is disposed between a baseband processor and the transmit antenna, and along a signal transmit path, the transmit channel usually includes components such as a frequency mixer, a radio frequency transceiver, a power amplifier, and a filter. The receive channel is disposed between the baseband processor and the receive antenna, and along a signal receive path, the receive channel usually includes components such as a filter, a low noise amplifier, and a demodulator. The radio frequency module transmits a signal through the transmit channel and the transmit antenna, and receives a signal through the receive channel and the receive antenna.

It should be noted that, based on specific hardware setting of the radio frequency module, for example, an operating frequency band of the antenna or a filtering frequency band of the filter, frequency bands supported by the first radio frequency module and the second radio frequency module may be the same or may be different. In an example, the first radio frequency module supports some LTE frequency bands but does not support the NR frequency band; and the second radio frequency module supports both some NR frequency bands and the LTE frequency band. Alternatively, both the first radio frequency module and the second radio frequency module support some LTE frequency bands and some NR frequency bands.

It may be understood that, for an electronic device on which a SIM card is installed, because both a frequency band supported by a radio frequency module of the electronic device and a frequency band supported by the SIM card are determinate, a frequency band supported by the electronic device is also determinate. In a process of accessing a cellular network, the electronic device can camp only on a frequency band supported by the electronic device. Similarly, a frequency band supported by the network side device is usually determinate due to hardware setting of the network side device. For example, an LTE base station usually supports operating on only some or all LTE frequency bands, and an NR base station usually supports operating on only some or all NR frequency bands. When connecting to a network side device, the electronic device needs to establish a connection by using a frequency band jointly supported by the electronic device and the network side device.

For an electronic device on which two SIM cards are installed, in a communication process, a first SIM card and a second SIM card of the electronic device each can usually find a cell of a proper frequency band for camping, so as to enter a dual SIM dual standby (dual SIM dual standby, DSDS) mode. Different from a DSDA mode, in the DSDS mode, the electronic device does not support concurrent dual-SIM services. For example, in a process in which the first SIM card processes a call service, the second SIM card cannot process a cellular data service; or in a process in which the first SIM card processes a cellular data service, if the second SIM card receives an incoming call, the data service of the first SIM card is interrupted.

To switch to the DSDA mode, the electronic device needs to enable a DSDA function, and frequency bands of cells on which the first SIM card and the second SIM card currently camp need to form a DSDA combination supported by the electronic device.

In a cellular communication process, the electronic device usually supports one or more DSDA combinations, and the supported DSDA combination is determinate. For ease of description, in this embodiment, “a frequency band number 1+a frequency band number 2” is used to represent one DSDA combination, where the frequency band number 1 is a frequency band number of a communication frequency band of the first SIM card, and the frequency band number 2 is a frequency band number of a communication frequency band of the second SIM card. For example, a DSDA combination “n41+Bi” is used to represent that the first SIM card camps on the n41 frequency band in the NR network, and the second SIM card camps on the Bi frequency band in the LTE network. Alternatively, a DSDA combination “n1+n41” is used to represent that the first SIM card camps on the n1 frequency band in the NR network, and the second SIM card camps on the n41 frequency band in the NR network.

After the electronic device enters a region, if the electronic device enables the DSDA function, and a wireless network in the region meets any DSDA combination of the electronic device, the electronic device may enter the DSDA operating mode in the region. That a wireless network in a region meets a DSDA combination means that frequency bands of the wireless network in the region include all frequency bands in the DSDA combination. Using a DSDA combination n1+B41 as an example, when frequency bands of a wireless network in a region A include both the n1 frequency band and the B41 frequency band, the wireless network in the region A satisfies the DSDA combination n1+B41.

It should be noted that, although network types that currently support the DSDA mode include the LTE network and the NR network, another network type (for example, a 6G network) that may be included in the future also falls within the scope of embodiments of this application, provided that the DSDA mode can be formed between two SIMs.

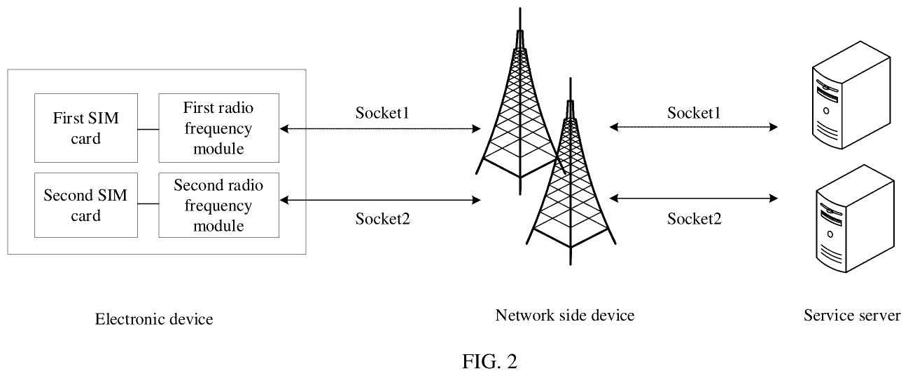

FIG. 2 is a diagram of a DSDA communication scenario according to an embodiment of this application. Refer to FIG. 2. That an electronic device performs communication by using a DSDA technology includes: accessing a cellular network by using a first SIM card and a first radio frequency module, and establishing a first socket connection (that is, Socket1) to a service server of a first service, to transmit a first service flow of the first service; and accessing a cellular network by using a second SIM card and a second radio frequency module, and establishing a second socket connection (that is, Socket2) to a service server of a second service, to transmit a second service flow of the second service, thereby implementing concurrent dual-SIM services, increasing a transmission rate of service data, and improving user experience.

It should be noted that the first service and the second service may be a same service, or may be different services. For example, when the first service is a call service, the second service is a data service; or both the first service and the second service are data services. The data service may be a video download service, a web page browsing service, or the like. In addition, when the first service and the second service are a same service, the first service and the second service usually correspond to a same service server; and when the first service and the second service are different services, the first service and the second service usually correspond to different service servers.

In some embodiments, in a high-speed communication scenario such as large file downloading and live streaming, an electronic device can simultaneously use two SIM cards to establish two service flows based on a DSDA technology to simultaneously transmit service data, so as to increase a communication rate. However, a DSDA function consumes a relatively large amount of traffic of the SIM card, which easily causes a waste of traffic resources. In addition, when traffic of the two SIM cards is unbalanced, and traffic of a primary SIM (for example, the first SIM card) is relatively large, but traffic of a secondary SIM (for example, the second SIM card) is relatively small, the DSDA function is likely to quickly exhaust traffic of the secondary SIM, and user experience is poor.

Therefore, an embodiment of this application provides a dual SIM dual active control method. Based on the method, an electronic device transmits service data of a target service only within a preset geo-fence by using the DSDA function. The method can reduce a waste of traffic resources of the electronic device.

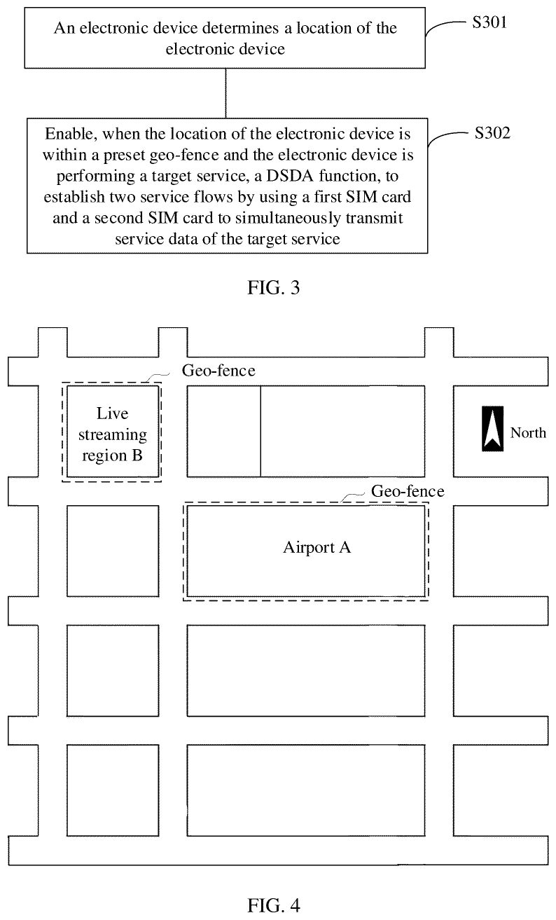

FIG. 3 is a schematic flowchart of a dual SIM dual active control method according to an embodiment of this application. Refer to FIG. 3. The method includes the following steps S301 and S302.

S301: An electronic device determines a location of the electronic device.

In some embodiments, the electronic device may determine the location of the electronic device by using a global positioning system (GPS) or a BeiDou navigation satellite system (BDS). The location may be determined or represented by using location information, and the location information may be longitude and latitude information or the like.

In some other embodiments, the electronic device may determine the location of the electronic device in a cellular positioning manner. For example, because currently base stations are disposed densely and have a wide coverage area, the electronic device can usually receive signals of a plurality of base stations at a same location. Based on this, when having a cellular positioning requirement, the electronic device may broadcast a cellular positioning request to the base stations, and receive positioning information sent by each base station in response to the request. The positioning information may include location information of the base station, location feature information of the electronic device, and the like. The electronic device may determine the location of the electronic device based on the positioning information sent by each base station.

S302: Enable, when the location of the electronic device is within a preset geo-fence and the electronic device is processing a target service, a DSDA function, to establish two service flows by using a first SIM card and a second SIM card to simultaneously transmit service data of the target service.

The geo-fence is a virtual geographical boundary, and may be understood as a virtual fence. A geographical region (for example, an airport A or a live streaming region B in FIG. 4) may be determined in real physical space by using the virtual fence. The geo-fence may be applied to various location based service (location based service, LBS) applications, for example, an entertainment application, an office application, an unmanned aerial vehicle control application, and a terminal positioning application. The geo-fence may be in various shapes, for example, a circle, an ellipse, a square, or another regular or irregular shape, which is not limited in this embodiment.

In this embodiment, a coverage area of the geo-fence is an effective range of the DSDA function of the electronic device, for example, a region in which a high-speed communication scenario usually exists, such as an airport, a live streaming region, a railway station, or a stadium. For example, to ensure flight safety of an aircraft, an electronic device is usually not allowed to enable a cellular communication function in a flight process. Therefore, a user may quickly download some video resources in advance at an airport to watch the video resources in the flight process. Therefore, the airport is a region in which a high-speed communication scenario exists. For another example, in a live streaming gathering place, to ensure that a live streaming picture is clear and does not freeze, an electronic device has a relatively high requirement on a communication rate. Therefore, the live streaming gathering place is also a region in which a high-speed communication scenario exists. Certainly, the preset region may also be another region, which is not specifically limited in this embodiment.

The target service is a service that supports use of the DSDA technology. For example, the target service may be audio and video download services of some audio and video playback applications (such as Huawei Video, Huawei Education, and Huawei Music), data upload/download services of some backup storage applications, some live streaming services, and the like. A type of the target service is not specifically limited in this embodiment.

In S302, the electronic device may determine, by using longitude and latitude information of the location of the electronic device, whether the electronic device is within the preset geo-fence. If the electronic device is located within the preset geo-fence, the electronic device transmits the service data of the target service by using the DSDA technology in a process of processing the target service. Specifically, the electronic device establishes a first service flow with a service server by using the first SIM card and a first radio frequency module, establishes a second service flow with the service server by using the second SIM card and a second radio frequency module, and transmits the service data of the target service by using both the first service flow and the second service flow, so as to increase a communication rate and further improve user experience.

According to the method provided in this embodiment of this application, the electronic device configures the DSDA function to take effect in the preset geo-fence, so that not only a waste of traffic resources caused by enabling the DSDA function for a long time can be avoided, but also user experience can be improved, thereby providing relatively good comprehensive use experience.

In this embodiment, the geo-fence may be a default geo-fence, or may be a geo-fence set by the electronic device based on a user operation. For example, the electronic device may select one or more target regions on an electronic map based on touch control of the user, and generate a corresponding geo-fence based on the target regions. When selecting the target region, the user may draw a boundary of the target region on the electronic map by using a touch operation, so as to determine the target region; or may first determine a center point of the target region, and then draw a circle based on the center and a target radius, so as to determine a circular target region. Alternatively, the electronic device may recommend some candidate regions (for example, a nearby airport, hospital, or stadium) to the user based on a location of the user, and the user may select a target region from these candidate regions, so that the electronic device generates a geo-fence based on the target region. A geo-fence determining process is not limited in this embodiment of this application.

The following further describes the DSDA control method provided in this embodiment of this application with reference to specific embodiments.

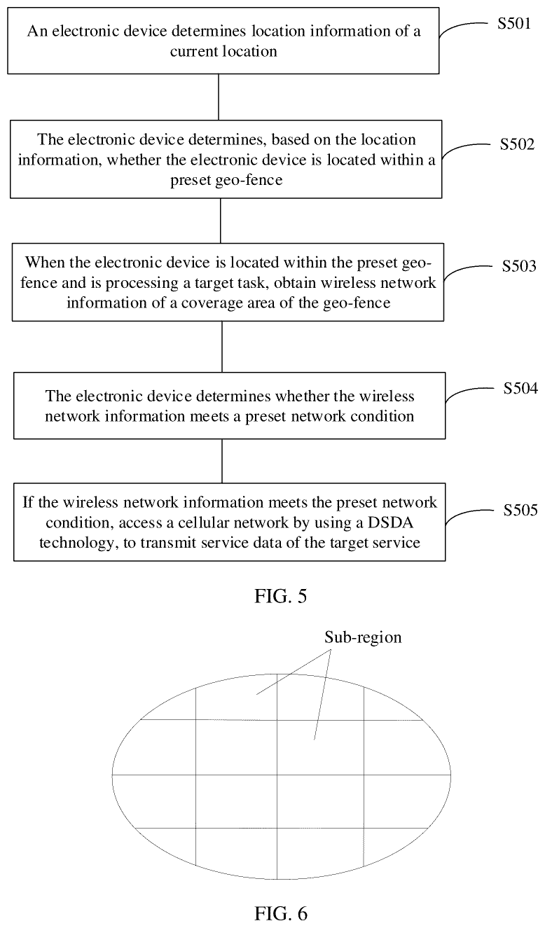

FIG. 5 is a schematic flowchart of a DSDA control method according to another embodiment of this application. The method includes the following steps S501 to S505.

S501: An electronic device determines location information of a current location. Reference may be made to S301, and details are not described in this embodiment.

S502: The electronic device determines, based on the location information, whether the electronic device is located within a preset geo-fence.

In an example, the geo-fence is a longitude and latitude range, and the location information of the electronic device is longitude and latitude information. Based on this, if the longitude and latitude information is within the longitude and latitude range corresponding to the geo-fence, it is considered that the electronic device is located within the geo-fence.

S503: When the electronic device is located within the preset geo-fence and is processing a target service, obtain wireless network information of a coverage area of the geo-fence.

In this embodiment, wireless network information of a region is used to represent a historical communication status of each electronic device in the region. For example, the wireless network information includes at least one of: operator information, a frequency band number, signal strength, an uplink/downlink congestion situation, a delay, a jitter, and a packet loss rate.

In some embodiments, a management server may establish a communication map for the coverage area of the geo-fence, so that an electronic device located within the geo-fence can determine, based on the communication map, wireless network information of a location of the electronic device.

The communication map is used to represent a communication status of each location in a geographical region. In this embodiment, refer to FIG. 6. The communication map includes a plurality of sub-regions and wireless network information of each sub-region. The sub-region may be a grid of a preset shape or a cell. A shape and a type of the sub-region are not limited in this embodiment of this application. A size of a sub-region reflects an area size of a geographical region corresponding to the sub-region. A smaller area of the sub-region indicates better precision of the communication map. On the contrary, a larger area of the sub-region indicates poorer precision of the communication map.

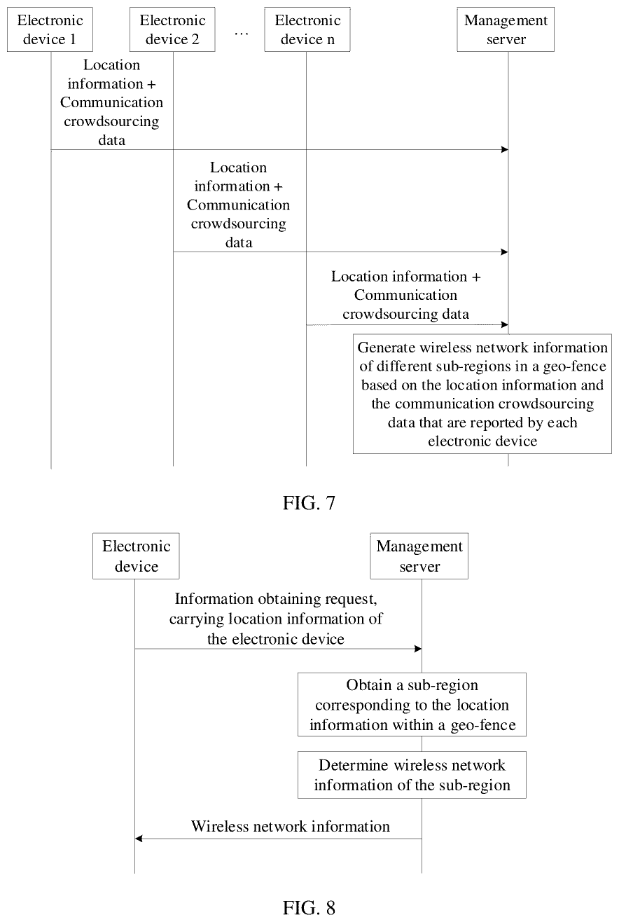

The communication map is usually determined based on map information of a target region and communication crowdsourcing data. For example, refer to FIG. 7. In a daily communication process, in a process of cellular communication, each electronic device (such as an electronic device 1 to an electronic device n) located within a geo-fence may report location information and communication crowdsourcing data of a location of the electronic device to a management server. The communication crowdsourcing data includes operator information and a frequency band number that are used in a current communication process of the electronic device, and signal strength, an uplink/downlink congestion situation, a delay, a jitter, a packet loss rate, and the like that are detected in the current communication process. The management server may generate a communication map based on the communication crowdsourcing data reported by each electronic device at each location.

In the communication map, wireless network information of each sub-region is used to represent a wireless communication status in the sub-region. It may be understood that, because distribution of base stations and software and hardware settings of the base stations are different, wireless network information of different sub-regions is usually different. In addition, because base stations of a plurality of different operators may cover a same sub-region, wireless network information of one sub-region may include information about a plurality of operators. In addition, because one base station generally supports a plurality of frequency bands, there are usually a plurality of frequency band numbers of wireless network information in one sub-region. Signal strength in wireless network information of a sub-region may be average signal strength of each electronic device in the sub-region in a communication process, an uplink/downlink congestion situation may be an average uplink/downlink congestion situation of each electronic device in the sub-region in the communication process, and a delay, a jitter, and a packet loss rate may also be an average delay, an average jitter, and an average packet loss rate of each electronic device in the sub-region in the communication process.

In this embodiment, a manner in which the electronic device obtains the wireless network information includes the following manner 1 and manner 2.

Manner 1: Obtain the wireless network information from the management server.

In some embodiments, refer to FIG. 8. If the electronic device is located within a preset geo-fence and is processing a target service, the electronic device sends an information obtaining request to the management server, where the information obtaining request carries location information of the electronic device. After receiving the information obtaining request, the management server searches for wireless network information of a corresponding sub-region based on the location information in the information obtaining request, and returns the wireless network information to the electronic device. It may be understood that the wireless network information obtained by the electronic device by using this method has relatively high real-time performance and accuracy.

Manner 2: Obtain the wireless network information locally.

In some embodiments, the electronic device may download or update a communication map of each geo-fence from the management server in advance, and locally store the communication map in the electronic device. Based on this, when determining that the electronic device is located within a preset geo-fence, the electronic device may directly search the local communication map for the wireless network information of the location of the electronic device. It may be understood that, the electronic device may quickly obtain, by using this method, the wireless network information of the location of the electronic device, thereby having relatively good user experience.

Optionally, the electronic device may further detect an amount of to-be-transmitted data of a target service. If the amount of the to-be-transmitted data is greater than a data amount threshold, S503 is performed; otherwise, the DSDA control procedure ends. For example, the amount of the to-be-transmitted data may be a size of a to-be-downloaded file (for example, a video file), a size of a to-be-uploaded file, or the like. In addition, the data amount threshold may be 300 M, 500 M, 1 G, or the like, which is not specifically limited in this embodiment. It may be understood that, at a same transmission speed, a process of transmitting a large file usually takes a relatively long time, and a process of transmitting a small file usually takes a relatively short time. Therefore, according to the method provided in this embodiment, the electronic device may enable the DSDA function when needing to transmit a relatively large file, so as to accelerate a transmission rate and improve user experience; and when transmitting a relatively small file, data traffic of a default SIM card is used, so as to reduce consumption of traffic of the other SIM card.

Optionally, the electronic device may further determine a device status of the electronic device. When the device status meets a device status condition, S503 is performed; otherwise, the DSDA control procedure ends. For example, the device status includes a device temperature, a remaining battery level of the device, and the like. Correspondingly, the device status condition includes: The device temperature is less than a temperature threshold, and/or the remaining battery level of the device is greater than a battery level threshold. The temperature threshold may be 37° C., 40° C., or the like, and the remaining battery level may be 20%, 30%, 40%, 50%, or the like of a fully charged battery level of the electronic device. This is not limited in this embodiment.

Optionally, the electronic device may further detect a current transmission speed of the service data of the target service. If the current transmission speed is less than a speed threshold, it indicates that a processing speed of the target service by the electronic device is relatively slow. In this case, the electronic device performs S503, so that the DSDA function is subsequently enabled, to increase the processing speed of the target service. If the current transmission speed is greater than or equal to the speed threshold, it indicates that the processing speed of the target service by the electronic device is relatively fast. Therefore, the wireless network information in the geo-fence does not need to be obtained to enable the DSDA function.

S504: The electronic device determines whether the wireless network information meets a preset network condition.

In this embodiment, the preset network condition includes at least one of the following content (1) to (7):
(1) Operator information in the wireless network information includes operator information corresponding to SIM cards used by the electronic device, and the SIM cards include a first SIM card and a second SIM card.
(2) A frequency band number in the wireless network information includes all frequency band numbers in any DSDA combination supported by the electronic device.
(3) Signal strength of a cell corresponding to a DSDA combination is greater than a signal strength threshold. For example, the signal strength threshold may be −90 dBm, −95 dBm, −100 dBm, or the like. This is not limited in this embodiment.
(4) An uplink/downlink congestion situation (congestion) of the cell corresponding to the DSDA combination meets a condition. For example, an uplink/downlink retransmission rate is less than a retransmission rate threshold, a round-trip time (round-trip time, RTT) is less than an RTT threshold, an average buffer time is less than a buffer time threshold, and a signal-to-noise ratio is greater than a signal-to-noise ratio threshold.
(5) A delay of the cell corresponding to the DSDA combination is less than a delay threshold. A delay is used to represent a time required for transmitting data from one end of a network to another end. It may be understood that a shorter delay indicates a higher data transmission rate. In this embodiment, the delay threshold may be 100 ms, 120 ms, or the like, which is not limited in this embodiment.
(6) A jitter time of the cell corresponding to the DSDA combination is less than a jitter time threshold. The jitter time is used to represent a time difference between a maximum delay and a minimum delay in a communication process. It may be understood that a shorter jitter time indicates a more stable delay in a data transmission process. In this embodiment, the jitter time threshold may be 15 ms, 20 ms, or the like, which is not limited in this embodiment.
(7) A packet loss rate of the cell corresponding to the DSDA combination is less than a packet loss rate threshold. The packet loss rate is a ratio of a quantity of lost data packets to a total quantity of sent data packets. It may be understood that a higher packet loss rate indicates poorer communication quality. In this embodiment, the packet loss rate threshold may be 0.01%, 0.05%, 0.1%, or the like, which is not limited in this embodiment.

S505: If the wireless network information meets the preset network condition, access a cellular network by using a DSDA technology, to transmit service data of the target service.

In this embodiment, that the electronic device performs communication by using the DSDA technology includes: accessing a cellular network by using a first SIM card and a first radio frequency module, and establishing a first socket connection (that is, Socket1) to a service server of the target service, to transmit a first service flow of the target service; and accessing a cellular network by using a second SIM card and a second radio frequency module, and establishing a second socket connection (that is, Socket2) to the service server of the target service, to transmit a second service flow of the target service. In other words, the electronic device uses two SIM cards to establish two service flows and simultaneously transmit the service data of the target service, thereby increasing a transmission rate.

Optionally, after the electronic device leaves the coverage area of the geo-fence, the electronic device automatically disables the DSDA function, to reduce traffic consumption of the electronic device. In an example, the electronic device usually sets a SIM with relatively large traffic as a default traffic SIM, for example, the first SIM card. Based on this, when disabling the DSDA function, the electronic device usually chooses to maintain the first service flow of the first SIM card, and disconnect the second service flow of the second SIM card, so as to preferentially use data traffic of a traffic SIM and reduce traffic consumption of the other SIM card.

To improve control experience of the user on the DSDA function, the electronic device may display a related control, and further enable/disable the DSDA function with reference to a control operation of the user.

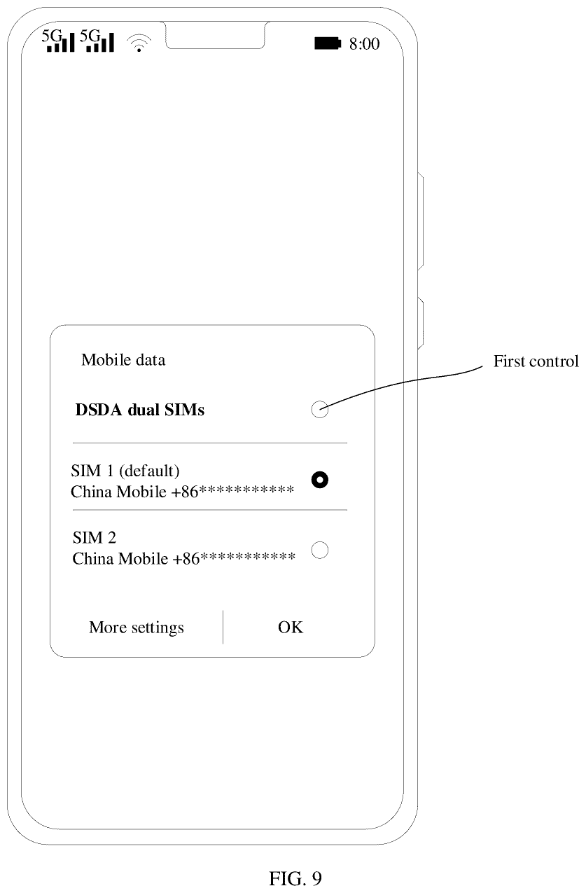

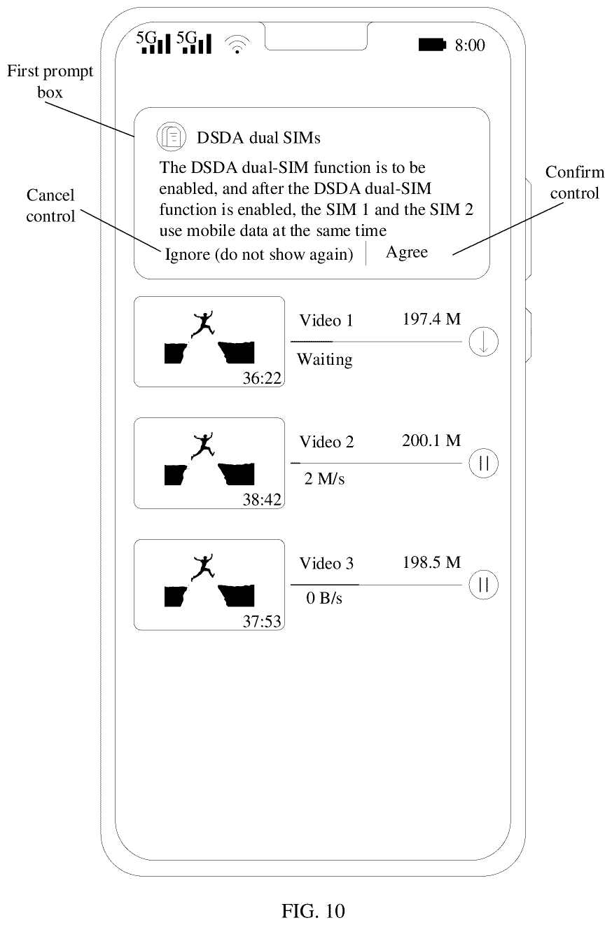

In some embodiments, refer to FIG. 9. A mobile data setting interface of the electronic device includes a first control, and the first control is used to control enabling or disabling of the DSDA function of the electronic device. Based on this, the user may manually enable/disable the DSDA function of the electronic device by using the first control. When the DSDA function is enabled, the electronic device performs communication by using the method (for example, S301 and S302 or S501 to S505) provided in the foregoing embodiment. However, when the DSDA function is disabled, the electronic device does not perform the method provided in the foregoing embodiment.

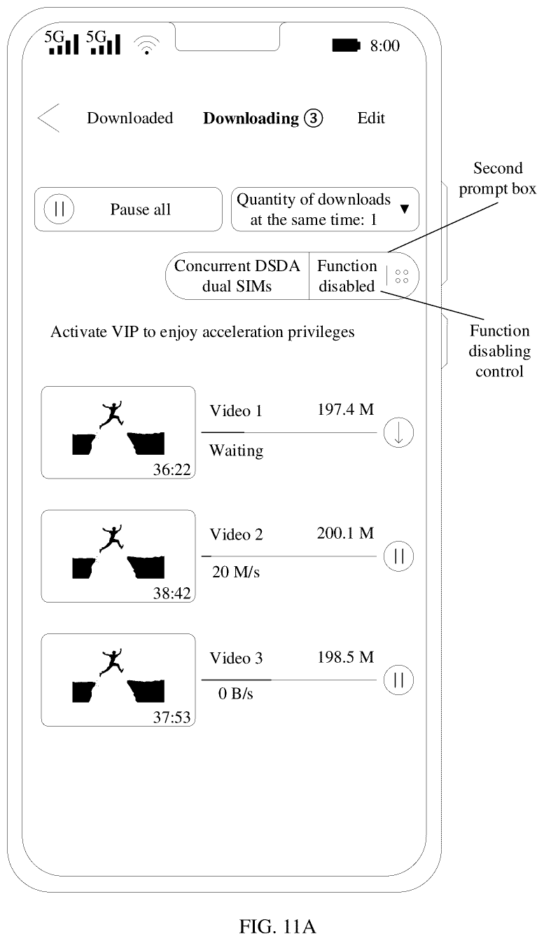

In some other embodiments, the electronic device displays a first prompt box when the electronic device is within the preset geo-fence and is processing the target service, where the first prompt box includes query information, a confirm control, and a cancel control. The query information is used to query the user whether to enable the dual SIM dual active function. For example, refer to FIG. 10. The query information may be that the DSDA dual-SIM function is to be enabled, and after the DSDA dual-SIM function is enabled, the SIM 1 and the SIM 2 use mobile data at the same time. The confirm control is used to confirm enabling of the DSDA function, and the cancel control is used to cancel displaying of the first prompt box. In response to a selection operation of the user on the confirm control, the electronic device enables the DSDA function when processing the target service, and establishes two service flows by using two SIM cards to simultaneously transmit the service data of the target service, thereby increasing a transmission rate. By using the first prompt box, when the electronic device is in an effective range of DSDA, the user may autonomously choose, based on a requirement, whether to enable the DSDA function.

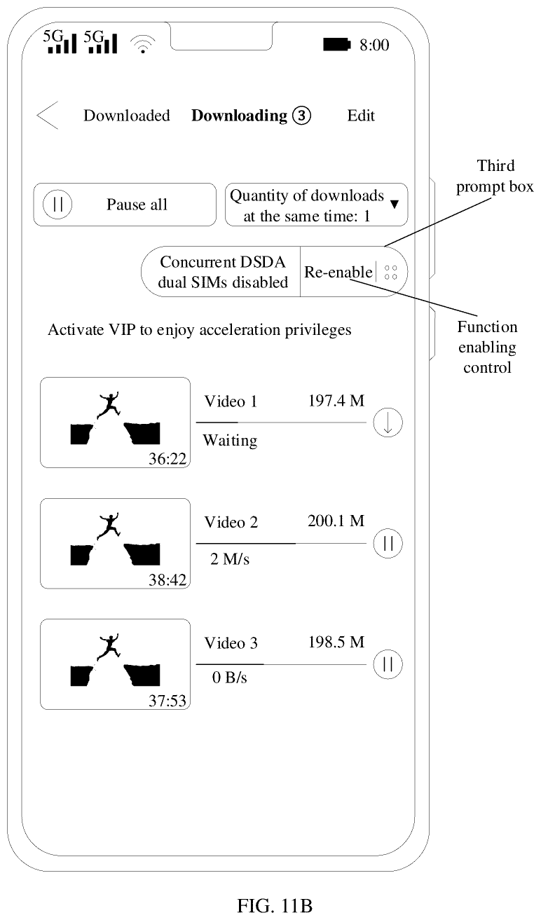

In still some other embodiments, refer to FIG. 11A. In a process of processing the target service by using the DSDA function, the electronic device may display a second prompt box, where the second prompt box includes prompt information and a function disabling control. The prompt information is used to prompt the user that the electronic device is currently using the DSDA function to process the target service, and the function disabling control is used to disable the DSDA function. The user may operate this disabling control to disable the DSDA function.

After the DSDA function is disabled, refer to FIG. 11B. The electronic device cancels displaying of the second prompt box, and displays a third prompt box. The third prompt box includes prompt information and a function enabling control. The prompt information is used to prompt the user that the DSDA function of the electronic device has been disabled. The function enabling control is used to enable the DSDA function. The user may operate the function enabling control to re-enable the DSDA function of the electronic device to process the target service.

Alternatively, when the electronic device is located within the preset geo-fence and meets the preset network condition and the preset device status condition, the electronic device may automatically display the third prompt box in the process of processing the target service, so that the user autonomously operates, in the third prompt box, whether to use the DSDA function to process the target service.

It can be learned that, according to the method provided in this embodiment, the user may autonomously control the electronic device whether to use the DSDA function to process the target service, thereby having relatively high user control experience.

Based on the foregoing description, before the electronic device enables the DSDA function, the first SIM card and the second SIM card of the electronic device usually camp on suitable cells in a DSDS mode. However, after the electronic device enables the DSDA function, two cells on which the first SIM card and the second SIM card of the electronic device originally camp in the DSDS mode do not necessarily support the electronic device in entering the DSDA mode. In other words, frequency bands of the cells on which the first SIM card and the second SIM card camp in the DSDS mode may not meet a DSDA combination supported by the electronic device. In this case, the electronic device needs to optimize a connection, so that the first SIM card and the second SIM card enter the DSDA mode.

In some embodiments, when the frequency bands on which the first SIM card and the second SIM card camp cannot form a DSDA combination, the electronic device may optimize a wireless network connection based on service statuses of the two SIMs, so that the electronic device enters the DSDA mode. The service status is specifically a status of a radio resource control (RRC) layer of a control plane protocol stack of the electronic device and a network side device. The RRC layer is used to control a connection between the electronic device and the network side device. The status of the RRC layer includes an RRC idle state (namely, RRC_IDLE) and an RRC connected state (namely, RRC_CONNECTED). Specifically, if the electronic device does not establish an RRC connection to a network device, the electronic device is in the RRC idle state. In the RRC idle state, the electronic device may perform public land mobile network (PLMN) selection, receive a system message broadcast by the network device, perform cell reselection, receive a paging message, or receive indication information indicating that the electronic device is paged. In addition, if the electronic device establishes an RRC connection to the network device, the electronic device is in the RRC connected state. In the RRC connected state, the electronic device may establish a user plane connection and a control plane connection to the network device, to transmit user plane data and control plane signaling.

The following separately describes a connection optimization method provided in embodiments of this application by using examples for cases in which the first SIM card and the second SIM card are in different service states.
(1) The first SIM card is in the RRC connected state, and the second SIM card is in the RRC idle state.

It may be understood that, in a process in which the electronic device processes the target service, when the first SIM card is in the RRC connected state, it indicates that the first SIM card is transmitting the service data of the target service. In this case, to avoid interrupting processing of the target service, the electronic device may perform cell reselection for the second SIM card, and select a target cell that supports the electronic device in entering the DSDA mode. Specifically, a frequency band number of a communication frequency band of the target cell needs to be able to form a DSDA combination with a frequency band number of a current communication frequency band of the first SIM card.

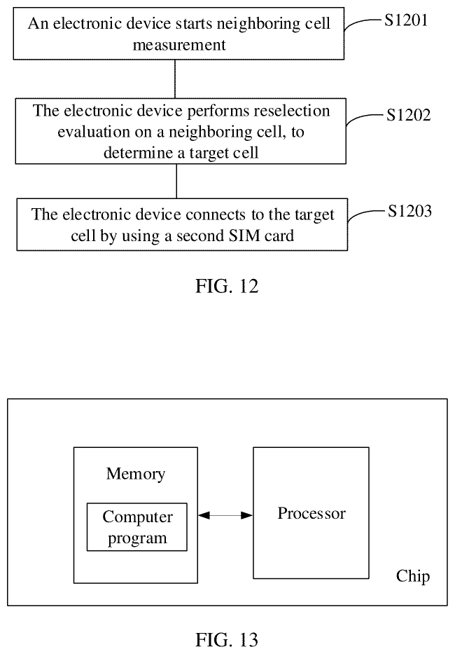

FIG. 12 is a schematic flowchart of performing cell reselection by an electronic device according to an embodiment of this application. Refer to FIG. 12. The process includes the following steps S1201 to S1203.

S1201: The electronic device starts neighboring cell measurement.

In a mobile communication system, a signal coverage area of a network side device or a part (for example, a sector antenna) of the network side device is referred to as a cell. In this embodiment, a cell on which the electronic device currently camps is referred to as a primary cell or a serving cell, and a cell that can be found by the electronic device currently but the electronic device does not camp is referred to as a neighboring cell, a neighboring cell, or a neighboring cell.

Generally, to ensure that an electronic device at an edge of a cell can find the cell, cells are generally distributed in an overlapping manner. Therefore, the electronic device can find a plurality of cells at some locations. Currently, after finding a plurality of cells, the electronic device selects, by default, a cell with a highest priority from the plurality of cells to camp on. After successfully camping on the cell, the electronic device may communicate with a network side device corresponding to the cell. For example, the electronic device may determine a priority of the cell based on reference signal received power (RSRP) or reference signal received quality (RSRP) of the cell. Larger RSRP or RSRQ indicates a higher priority.

The electronic device may perform cell reselection after camping on a suitable cell and staying for a proper time (for example, 1 second), to ensure to a maximum extent that an electronic device in an RRC idle state camps on a most suitable cell.

That the electronic device camps on an NR cell is used as an example. The electronic device may start neighboring cell measurement in the following case 1 or case 2, to perform cell reselection.

### Case 1:

(1) A neighboring cell with a higher-priority NR frequency channel number meets the following condition during timing by an NR cell reselection timer (namely, TreselectionNR): S_{qual}>Thresh_{X, HighQ}. S_{qual} is an RSRQ value of the neighboring cell. Thresh_{X, HighP} is an RSRQ threshold for high-priority reselection.
(2) The electronic device camps on a current serving cell for more than 1 second.

### Case 2:

(1) A neighboring cell with a higher-priority NR frequency channel number meets the following condition during timing by TreselectionNR: Sᵣₓₗₑᵥ>Thresh_{X, HighP}. Sᵣₓₗₑᵥ is an RSRP value of the neighboring cell. Thresh_{X, HighP} is an RSRP threshold for high-priority reselection.

It should be noted that an NR frequency channel number is a number of a fixed frequency in an NR frequency band, and one NR frequency band usually includes a plurality of NR frequency channel numbers. In a communication process, the electronic device specifically uses an NR frequency channel number in an NR frequency band for communication.
(2) The electronic device camps on a current serving cell for more than 1 second.

In this embodiment, because the electronic device usually selects a cell with a highest priority to camp on, the electronic device may start neighboring cell measurement in a manner of reducing a priority of a serving cell.

S1202: The electronic device performs reselection evaluation on a neighboring cell, to determine a target cell.

After finding a plurality of neighboring cells, the electronic device first needs to determine, based on frequency bands of these neighboring cells, some candidate cells whose frequency bands can form DSDA combinations with a frequency band on which a first SIM card currently communicates. Then, a target cell is further determined from these candidate cells for connection.

Specifically, if only one candidate cell exists, the electronic device determines the candidate cell as the target cell. If there are a plurality of candidate cells, the electronic device may determine a candidate cell with a highest signal quality level Rn as the target cell.

$${R}_{n} = {Q}_{meas , n} - {Q}_{offset} - {Q}_{offsettemp}$$

Q_{meas,n} is RSRP of the candidate cell, Q_{offset} is a neighboring cell reselection offset of the candidate cell, and Q_{offsettemp} is a penalty factor introduced for a cell in which a timer T300 expires for a plurality of times. To be specific, a penalty factor used when the electronic device sends an RRC setup request message RRCSetupRequest for a plurality of times in the cell but does not receive an RRC setup message RRCSetup.

S1203: The electronic device connects to the target cell by using a second SIM card.

In conclusion, based on the foregoing steps S1201 to S1203, after connecting to the target cell by using the second SIM card, the electronic device may enter a DSDA mode, and establish two service flows by using two SIM cards to simultaneously transmit service data of a target service.
(2) Both the first SIM card and the second SIM card are in an RRC connected state.

When the first SIM card and the second SIM card cannot form DSDA, and both are in the RRC connected state, if RRC reestablishment occurs on the first SIM card, the electronic device may search for a target cell for the first SIM card again by using an RRC reestablishment process, and establish an RRC connection to a network side device corresponding to the target cell. A frequency band number of a communication frequency band supported by the target cell is able to form a DSDA combination with a frequency band number of a currently used communication frequency band of the second SIM card.

In this embodiment, a process in which the electronic device enables the first SIM card to connect to the target cell through RRC reestablishment includes the following content (1) to (10):
(1) If a timer T310 is running, stop T310 and start a timer T311.

The timer T310 is a timer for the electronic device to monitor a radio link failure. When detecting that a problem occurs at a physical layer of a serving cell, the electronic device starts the timer T310. In addition, the electronic device may stop the timer T310 when initiating an RRC connection reestablishment procedure. The timer T311 is a timer of a waiting time for the electronic device to enter an RRC_IDLE state after monitoring a radio link failure. When initiating initial RRC connection reestablishment, the electronic device starts the timer T311. After reselecting a proper NR cell, the electronic device stops the timer T311. When the timer expires, the electronic device enters the RRC_IDLE state.
(2) Suspend all radio bearers (RB) except a signaling radio bearer SRB0.
(3) Reset a media access control (MAC) layer.
(4) Configure a default physical channel and a semi-persistent scheduling configuration at a physical (PHY) layer.
(5) Configure a default MAC configuration at the MAC layer.
(6) Perform a cell search process.
(7) After the target cell is found, stop T311 and start the timer T301. A frequency band number of a communication frequency band supported by the target cell is able to form a DSDA combination with a frequency band number of a currently used communication frequency band of the second SIM card.

The timer T301 is a timer for the electronic device to wait for an RRC reestablishment response. When sending an RRC reestablishment request message RRC Reestablishment Request, the electronic device starts the timer T301. After receiving an RRC connection reestablishment message RRC Reestablishment or an RRC connection reestablishment reject message RRC Reestablishment Reject, the electronic device stops the timer T301. When the timer T301 expires, the electronic device enters the RRC_IDLE state.
(8) Send an RRC reestablishment request message RRCReestablishment Request to a network side device corresponding to the target cell, to trigger a random access procedure.
(9) Receive an RRC reestablishment message RRCReestablishment sent by the network side device.
(10) Send an RRC reestablishment complete message RRC Reestablishment Complete to the network side device, to complete RRC reestablishment with the network side device.

It should be understood that sequence numbers of the steps do not mean an execution sequence in the foregoing embodiments. The execution sequence of the processes should be determined based on functions and internal logic of the processes, and should not constitute any limitation on the implementation processes of embodiments of this application.

An embodiment of this application further provides an electronic device. The electronic device supports disposing of a first SIM card and a second SIM card, and includes a memory, a processor, and a computer program that is stored in the memory and that is capable of running on the processor, and when executing the computer program, the processor implements the DSDA control method shown in the foregoing embodiments.

An embodiment of this application further provides a chip. As shown in FIG. 13, the chip includes a processor and a memory. The memory stores a computer program. When the computer program is executed by the processor, the DSDA control method shown in the foregoing embodiments is implemented.

An embodiment of this application further provides a computer-readable storage medium. The computer-readable storage medium stores a computer program. When the computer program is executed by a processor, the DSDA control method shown in the foregoing embodiments is implemented.

An embodiment of this application further provides a computer program product. The program product includes a computer program. When the computer program is run by an electronic device, the electronic device is enabled to implement the DSDA control method shown in the foregoing embodiments.

It should be understood that, the processor mentioned in embodiments of this application may be a central processing unit (CPU), and may further be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It may be understood that the memory mentioned in embodiments of this application may be a volatile memory or a nonvolatile memory, or may include a volatile memory and a nonvolatile memory. The nonvolatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus random access memory (direct rambus RAM, DR RAM).

In embodiments provided in this application, division into the frameworks or modules is merely logical function division and there may be another division manner in actual implementation. For example, a plurality of frameworks or modules may be combined or integrated into another system, or some features may be ignored or not performed.

In addition, functional modules in embodiments of this application may be integrated into one processing module, or each of the modules may exist alone physically, or two or more modules may be integrated into one module. The integrated module may be implemented in a form of hardware, or may be implemented in a form of a software functional module.

It may be clearly understood by persons skilled in the art that, for the purpose of convenient and brief description, for a detailed working process of the foregoing system, apparatus, and unit, refer to a corresponding process in the foregoing method embodiments. Details are not described herein again.

Reference to “one embodiment” or “some embodiments” described in the specification of this application means that one or more embodiments of this application include a specific feature, structure, or feature described with reference to embodiment. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

The foregoing embodiments are merely intended to describe the technical solutions of this application, but are not to limit this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of embodiments of this application, and these modifications and replacements shall fall within the protection scope of this application.

What is claimed is:

1. A method, applied to an electronic device, and the method comprising:
determining a location of the electronic device, wherein the electronic device supports a first subscriber identity module (SIM) card and a second SIM card; and
enabling, when the location of the electronic device is within a preset geo-fence and the electronic device is processing a target service, a dual SIM dual active (DSDA) function, to establish two service flows by using the first SIM card and the second SIM card to simultaneously transmit service data of the target service.

2. The method according to claim 1, wherein enabling, when the location of the electronic device is within the preset geo-fence and the electronic device is processing the target service, the DSDA function, to establish the two service flows by using the first SIM card and the second SIM card to simultaneously transmit the service data of the target service comprises:
when the location of the electronic device is within the preset geo-fence and the electronic device is performing the target service, obtaining wireless network information within the geo-fence, wherein the wireless network information represents historical communication statuses of a plurality of other electronic devices; and
when the wireless network information meets a preset network condition, enabling the DSDA function, to establish the two service flows by using the first SIM card and the second SIM card to simultaneously transmit the service data of the target service.

3. The method according to claim 2, wherein the wireless network information comprises at least one of: operator information, a frequency band number, signal strength, an uplink or downlink congestion situation, a delay, a jitter, or a packet loss rate.

4. The method according to claim 3, wherein the preset network condition comprises: the frequency band number in the wireless network information comprises a frequency band number in a DSDA combination supported by the electronic device.

5. The method according to claim 4, wherein the preset network condition further comprises:
the signal strength is greater than a signal strength threshold;
the delay is less than a delay threshold;
time of the jitter is less than a jitter time threshold; or
the packet loss rate is less than a packet loss rate threshold.

6. The method according to claim 2, wherein the geo-fence comprises a plurality of sub-regions, and obtaining the wireless network information within the geo-fence comprises:
sending location information of a current location of the electronic device to a network side device; and
receiving the wireless network information that is of a first sub-region in which the electronic device is located and that is returned by the network side device, wherein the first sub-region is determined by the network side device within the geo-fence based on the location information.

7. The method according to claim 6, wherein each sub-region is a grid of a preset shape or a cell.

8. The method according to claim 1, wherein enabling the DSDA function comprises:
determining a device status of the electronic device, and when the device status meets a device status condition, enabling the DSDA function;
determining a data amount of the service data of the target service, and when the data amount is greater than a data amount threshold, enabling the DSDA function; or
determining a data transmission rate at which the electronic device currently transmits the service data of the target service, and when the data transmission rate is less than a rate threshold, enabling the DSDA function.

9. The method according to claim 8, wherein the device status condition comprises:
a temperature of the electronic device is less than a temperature threshold; or
a remaining battery level of the electronic device is greater than a battery level threshold.

10. The method according to claim 1, wherein a setting interface of the electronic device comprises a first control, and the first control is used to control enabling or disabling of the DSDA function.

11. The method according to claim 1, wherein enabling, when the location of the electronic device is within the preset geo-fence and the electronic device is processing the target service, the DSDA function, to establish the two service flows by using the first SIM card and the second SIM card to simultaneously transmit the service data of the target service comprises:
displaying a first prompt box when the location of the electronic device is within the preset geo-fence and the electronic device is processing the target service, wherein the first prompt box comprises query information and a confirm control, and the query information is used to query a user whether to enable the dual SIM dual active function; and
enabling, by the electronic device, the DSDA function in response to a selection operation for the confirm control, to establish the two service flows by using the first SIM card and the second SIM card to simultaneously transmit the service data of the target service.

12. The method according to claim 1, further comprising:
displaying a second control in a process of establishing the two service flows by using the first SIM card and the second SIM card to simultaneously transmit the service data of the target service, wherein the second control is used to control disabling of the DSDA function of the electronic device.

13. The method according to claim 1, further comprising:
after the DSDA function is enabled, when frequency band numbers currently for the first SIM card and the second SIM card to communicate cannot form a DSDA combination supported by the electronic device, when the first SIM card is in a radio resource control (RRC) connected state, and the second SIM card is in an RRC idle state, performing cell reselection on a cell on which the second SIM card camps, wherein a frequency band number of a target cell on which the second SIM card camps after reselection is able to form the DSDA combination with the frequency band number currently for the first SIM card to communicate.

14. The method according to claim 1, further comprising:
after the DSDA function is enabled, when frequency band numbers currently for the first SIM card and the second SIM card to communicate cannot form a DSDA combination supported by the electronic device, when both the first SIM card and the second SIM card are in a radio resource control (RRC) connected state, when the first SIM card is disconnected from a current serving cell, controlling the second SIM card to determine a target cell and establish an RRC connection to the target cell by using an RRC reestablishment procedure, wherein a frequency band number of the target cell is able to form the DSDA combination with the frequency band number currently used by the second SIM card to communicate.

15. The method according to claim 1, further comprising:
disabling the DSDA function after it is detected that the electronic device leaves the preset geo-fence.

16. An electronic device, comprising:
memory, at least one processor, and a computer program that is stored in the memory and that is capable of running on the at least one processor, and wherein when executing the computer program, the electronic device is caused to:
determine a location of the electronic device wherein the electronic device supports a first subscriber identity module (SIM) card and a second SIM card, and; and
enable, when the location of the electronic device is within a preset geo-fence and the electronic device is processing a target service, a dual SIM dual active (DSDA) function, to establish two service flows by using the first SIM card and the second SIM card to simultaneously transmit service data of the target service.

17. The electronic device according to claim 16, wherein enabling, when the location of the electronic device is within the preset geo-fence and the electronic device is processing the target service, the DSDA function, to establish the two service flows by using the first SIM card and the second SIM card to simultaneously transmit the service data of the target service comprises:
when the location of the electronic device is within the preset geo-fence and the electronic device is performing the target service, obtaining wireless network information within the geo-fence, wherein the wireless network information represents historical communication statuses of a plurality of other electronic devices; and
when the wireless network information meets a preset network condition, enabling the DSDA function, to establish the two service flows by using the first SIM card and the second SIM card to simultaneously transmit the service data of the target service.

18. The electronic device according to claim 17, wherein the wireless network information comprises at least one of: operator information, a frequency band number, signal strength, an uplink or downlink congestion situation, a delay, a jitter, or a packet loss rate.

19. The electronic device according to claim 18, wherein the preset network condition comprises: the frequency band number in the wireless network information comprises a frequency band number in a DSDA combination supported by the electronic device.

20. The electronic device according to claim 19, wherein the preset network condition further comprises:
the signal strength is greater than a signal strength threshold;
the delay is less than a delay threshold;
time of the jitter is less than a jitter time threshold; or
the packet loss rate is less than a packet loss rate threshold.
